(19) United States
(12) Patent Application Publication
(10) Pub. No.: US 2011/0113200 A1
(43) Pub. Date: May 12, 2011

(54) METHODS AND APPARATUSES FOR CONTROLLING CACHE OCCUPANCY RATES

(76) Inventors: Jaideep Moses, Portland, OR (US); Rameshkumar G. Illikkal, Portland, OR (US); Donald K. Newell, Portland, OR (US); Ravishankar Iyer, Portland, OR (US); Kostantinos Alsopos, Boston, MA (US); Li Zhao, Beaverton, OR (US)

(21) Appl. No.: 12/616,066

(22) Filed: Nov. 10, 2009

(51) Int. Cl. G06F 12/08; G06F 12/00; G06F 12/02

(52) U.S. Cl. 711/130; 711/170; 711/E12.001; 711/E12.002; 711/E12.023

(57) ABSTRACT

Embodiments of an apparatus for controlling cache occupancy rates are presented. In one embodiment, an apparatus comprises a controller and monitor logic. The monitor logic determines a monitored occupancy rate associated with a first program class. The first controller regulates a first allocation probability corresponding to the first program class, based at least on the difference between a requested occupancy rate and the first monitored occupancy rate.

### FIELD OF THE INVENTION

Embodiments of the invention relate to the field of computer systems; more particularly, to processing of cache allocation requests.

### BACKGROUND OF THE INVENTION

In general, a cache memory includes memory between a shared system memory and execution units of a processor to hold information in a closer proximity to the execution units of the processor. Caches are often identified based on their proximity from execution units of a processor. For example, a first-level (L1) cache may be close to execution units residing on the same physical processor. A computer system may also hold higher-level cache memories, such as, a second level cache and a third level cache which reside on the processor or elsewhere in the computer system.

Cache memories are typically unaware of how cache lines are allocated to multiple programs. When a processor issues a load/store request for a data block in a cache memory, the processor checks for the data block in the cache. If the data block is not in the cache, the cache controller issues a request to the main memory. Upon receiving a response from the main memory, the cache controller allocates the data block into the cache. Often, selection of a cache line to replace with the newly retrieved block of data is based on a time or use algorithm, such as a Least Recently Used (LRU) cache replacement algorithm.

Multi-threaded cores, multi-core processors, virtualized cores, multiple application streams, or combinations thereof in processing systems may interfere with each other and as a result, may cause a shared cache to operate inefficiently. For example, a low priority program is associated with a lower priority level than a priority of a higher priority program. However, the low priority program may generate more allocation requests, which monopolize the cache usage (i.e., evict lines associated with the high priority program) and consequently degrade the performance of the high priority program.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 shows an embodiment of a computer system including an apparatus to control a cache occupancy rate, based on feedback from monitored results.

FIG. 2 is a flow diagram of one embodiment of a process to control cache occupancy rates.

FIG. 3 illustrates a computer system for use with one embodiment of the present invention.

FIG. 4 illustrates a point-to-point computer system for use with one embodiment of the invention.

### DETAILED DESCRIPTION OF THE INVENTION

Embodiments of methods and apparatuses for controlling cache occupancy rates associated with different program classes are presented. In one embodiment, monitor logic determines a monitored occupancy rate associated with a program class. A controller regulates an allocation probability corresponding to the program class, based at least on the difference between the monitored occupancy rate and a requested occupancy rate. In one embodiment, a controller regulates the allocation probability in conjunction with a feedback mechanism including a proportional-integral-derivative controller (PID controller).

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

In other instances, well-known components or methods, such as, for example, microprocessor architecture, virtual machine monitor, power control, clock gating, and operational details of known logic, have not been described in detail in order to avoid unnecessarily obscuring the present invention.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The methods and apparatuses described herein are for regulating an allocation probability associated with a program class. Specifically, regulating an allocation probability is discussed in reference to multi-core processor computer systems. However, the methods and the apparatuses for regulating an allocation probability are not so limited, as they may be implemented on or in association with any integrated circuit device or system, such as cell phones, personal digital assistants, embedded controllers, mobile platforms, desktop platforms, and server platforms, as well as in conjunction with any type of processing element, such as a core, a hardware thread, a software thread, or a logical processor, an accelerator core or other processing resource.

### Overview

Embodiments of methods and an apparatuses for controlling cache occupancy rates associated with different program classes are presented. In one embodiment, monitor logic determines a monitored occupancy rate associated with a program class. A controller regulates an allocation probability corresponding to the program class, based at least on the difference between the monitored occupancy rate and a requested occupancy rate. In one embodiment, a controller regulates the allocation probability in conjunction with a feedback mechanism including a proportional-integral-derivative controller (PID controller).

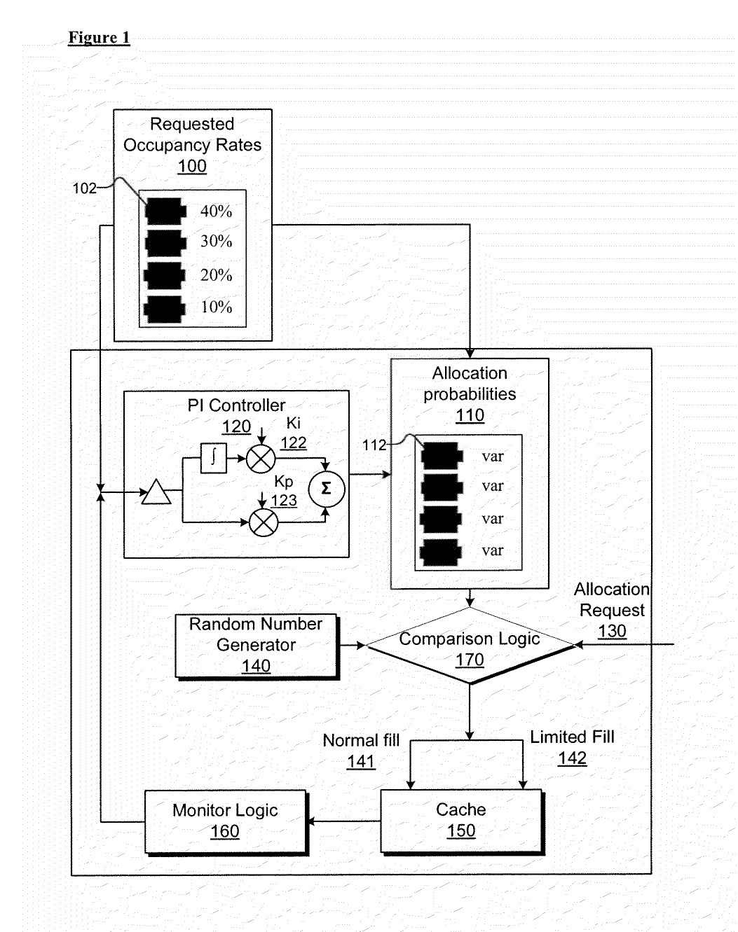

FIG. 1 shows an embodiment of a computer system including an apparatus to control a cache occupancy rate, based on feedback from monitored results. Many related components such as buses and peripherals have not been shown to avoid obscuring the invention. Referring to FIG. 1, In one embodiment, the computer system includes requested occupancy rates 100, proportional-integral controller (PI controller) 120, monitor logic 160, comparison logic 170, random number generator 140, cache 150, and memory (not shown). In one embodiment, PI controller 120, comparison logic 170, cache 150, or any combination thereof is integrated in a processor. In one embodiment, cache 150 is a cache level 1 dedicated to a core.

In one embodiment, a computer system includes input/output (I/O) buffers to transmit and receive signals via interconnect. Examples of the interconnect include a Gunning Transceiver Logic (GTL) bus, a GTL+ bus, a double data rate (DDR) bus, a pumped bus, a differential bus, a cache coherent bus, a point-to-point bus, a multi-drop bus or other known interconnect implementing any known bus protocol.

In one embodiment, requested occupancy rates 100 is a user configurable setting. In other embodiment, requested occupancy rates 100 is determined based on a power saving profile, a user setting, an operating system, a system application, a user application, or the like.

In one embodiment, requested occupancy rate 102 is a requested occupancy rate associated with a program class (i.e., program class A). In one embodiment, each program class is of a different execution priority level. In one embodiment, a cache, such as cache 150, receives cache allocation request 130 from programs of different program classes (e.g., A, B, C, and D) associated with different priority levels. A cache allocation requests is associated with the priority based on the source of the request (from which program the request originates).

In one embodiment, requested occupancy rates 100 stores target values of cache occupancy rates associated with several program classes. In one embodiment, a requested occupancy rate is a target percentage utilization of a program class in cache 150. For example, requested occupancy rate 102 associated with program class A is set to achieve 40% utilization in cache 150. In one embodiment, a program class of a higher priority (e.g., program class A) is assigned with a higher requested occupancy rate. In one embodiment, a requested occupancy rate is also referred to as a requested cache occupancy rate, or a requested allocation.

It will be appreciated by those skilled in the art that a cache may be organized in any manner, such as multiple lines within multiple sets and ways. As a result, other examples of usage may include a number of blocks or a percentage of blocks, which in different embodiments refers to a number of lines, a percentage of sets a number of lines, a percentage of sets, a number of ways, and a percentage of ways. Additionally, the percentage values may be represented in a ratio, a number within a specific range, a decimal, or the like.

In one embodiment, monitor logic 160 receives or determines data, such as, for example, cache occupancy, cache line fills, cache line evictions, power consumption, memory capacity, and input/output requests, which are associated with usage of various shared resources. In one embodiment, monitor logic 160 is a part of a processor performance monitoring components, an integrated part of platform components, or both.

In one embodiment, monitor logic 160 determines a monitored occupancy rate associated with each program class (e.g., program classes A-D). In one embodiment, monitor logic 160 monitors or determines utilization or consumption of cache 150 according to different program classes (of different priority levels). In one embodiment, monitor logic 160 determines continually utilization associated with a program class in cache 150. For example, a number of lines associated with program class A is divided by the total number of lines monitored to obtain a percentage of utilization. Note from the discussion above, that a cache may be organized in any manner, such as multiple lines within multiple sets and ways. As a result, other examples of usage may include a number of blocks or a percentage of blocks, which in different embodiments refers to a number of lines, a percentage of sets a number of lines, a percentage of sets, a number of ways, and a percentage of ways. In one embodiment, a monitored occupancy rate is also referred to as a monitored cache occupancy rate, a resulting occupancy rate, or a resulting allocation rate.

In one embodiment, monitor logic 160 monitors only a sample portion/group or a sample size of cache 150 to obtain a statistical representation of cache 150. For example, if there are 100 lines being monitored and data associated with program class A is held in 90 of the 100 lines, then the cache utilization/consumption is determined to be 90% of cache 150. In one embodiment, monitor logic 160 monitors utilization for a subset of a cache memory, i.e., a sample size. In one embodiment, for example, a cache memory is a 16-way cache memory organized as 4096 sets. Monitor logic 160 monitors 200 sets of the cache memory which is about 5% of the total number of sets. In one embodiment, the sample size for a cache memory is from 1% to 50% of portions in the cache memory wherein the portions are data elements within a cache line, lines, sets, or ways.

In one embodiment, PI controller 120 is coupled to requested occupancy rates 100 to receive a set point (e.g., requested occupancy rate 102). In one embodiment, PI controller 120 also receives feedback data (e.g., a monitored cache occupancy rate associated with program class A from monitor logic 160).

In one embodiment, PI controller 120 is configured by changing parameters such as, an integral gain (Ki) 122 and a proportional gain (Kp) 123. In one embodiment, PI controller 120 further comprises a derivative gain (Kd). In one embodiment, Kp is set to 0.6, Ki is set to 0.2, and Kd is set to 0. In one embodiment, output from PI controller is set based on Kp*error+Ki*Σerror+Kd*Δerror, where error is the difference (deviation) between a requested occupancy rate and a monitored occupancy rate.

In one embodiment, PI controller 120 is used to reduce an overshoot and ringing effect, such that the regulating mechanism does not react too quickly to feedback of performance data. In other words, PI controller 120 provides a smoother output response than simple rule-based determination. In one embodiment, parameters (e.g., Kp, Ki, and Kd) are adjusted to improve the response of an output from PI controller 120. It will be appreciated by those skilled in the art that these parameters may be scaled up or down to adjust a degree of aggressiveness of a control mechanism.

In one embodiment, PI controller 120 regulates allocation probability 112 associated with the program class A. In one embodiment, PI controller 120 is able to increase allocation probability 112 if a monitored occupancy rate is in an underflow condition. In one embodiment, PI controller 120 is able to decrease allocation probability 112 if a monitored occupancy rate is in an overflow condition. In one embodiment, a different PI controller regulates an allocation probability associated with each separate program class.

In one embodiment, allocation probabilities 110 receive information from requested occupancy rates 100 and PI controller 120. In one embodiment, allocation probabilities 110 set the initial values allocation probability 112 based on requested occupancy rate 102. Subsequently, allocation probability 112 is regulated by PI controller 120.

In one embodiment, an allocation probability is also referred to as an allocation rate, or an allocation threshold. In one embodiment, allocation probability 102 represents a value, such as a ratio, a percentage value, a value within a specific range, or the like.

In one embodiment, comparison logic 170 probabilistically determines whether cache allocation request 130 should be filled normally or on a limited basis based on priority. In one embodiment, comparison logic 170 determines to perform a limited fill if a random number generated is larger than allocation probability 112. Otherwise, comparison logic 170 determines to perform in a normal fill. In one embodiment, random number generator 140 generates the random number.

In one embodiment, a normal fill and a limited fill are based on a probability selective allocation mechanism as described in a currently pending application entitled, “Priority Aware Selective Cache Allocation,” with application Ser. No. 11/965,131. In one embodiment, as an example, a normal fill is performed in conjunction with a normal replacement algorithm (e.g., Last Recent Used (LRU) algorithm) to select a line to evict and the line is filled with data based on allocation request 130. Performing a normal fill operation is referred to herein as a normal fill.

In one embodiment, any known method of limiting a fill to a cache (performing a cache fill with limitation deviating from a normal fill) is referred to herein as a limited fill. In one embodiment, a limited fill includes a fill to a line of the cache memory in response to a cache allocation request without updating a replacement algorithm state of the line. For example, if an LRU state of a cache line indicates that it is a next cache line to be evicted, then the LRU state is not updated upon performing a limited fill. In contrast, a normal fill updates the LRU state because data was recently placed in the cache. This is an example of temporally limiting a fill to the cache.

In one embodiment, a limited fill includes performing a fill to a line of the cache memory in response to a cache allocation request and not updating a replacement algorithm in response to a subsequent hit to the line. In the previous example, an LRU state was not updated when the fill was performed. However, if a subsequent hit to the line occurred, the LRU state would be modified, as it was recently used. Yet, in this example, whether the LRU state was modified or not upon the original fill, the LRU state is not modified even when subsequently hit. As a result, even if a low priority program repeatedly accesses a line that was limitedly filled, the line may be chosen by an LRU algorithm for eviction. Consequently, the low priority thread may not over utilize the cache. This method is referred to herein as “Keep 0 on hits” (KOH).

In one embodiment, a limited fill includes filling to a limited portion of cache 150. For example, a smaller number of ways or sets than the total number of ways or sets are utilized as a filling area for limited fills. To illustrate, assume cache 150 is an 8-way set associative cache. A single way of cache 150 is designated for limited fills. As a result, the single way potentially includes a large number of limited fills contending for space. In one embodiment, however, 7-ways of cache 150 are only allocated normally based on allocation probabilities. As a result, low priority programs with high cache allocation request rates potentially affects the performance of only one way, while the rest of the ways substantially resemble the probabilistic allocation between priority levels. This method is referred to herein as “One-way buffer” (1 WB).

In one embodiment, cache control logic performs a limited fill or a normal fill based on the result from comparison logic 170. As an example, if the allocation probability is 0.60 (an occupancy rate is in the range of 0 to 1) and the random number is 0.50, then a normal fill is performed, because the random number is less than the allocation probability. In contrast, if the random number is 0.61, then a limited fill is performed. In one embodiment, cache control logic is able to perform any of the limited fills (e.g., KOH, 1 WB, etc.) and combinations thereof. In one embodiment, cache control logic is a part of cache 150.

In one embodiment, an allocation probability number and a random number comparison may be inverted. For example, performing normal fills if a random number is greater than an allocation of 0.4 is essentially identical to the example above, i.e., for 60 out of 100 numbers a normal fill will be performed and for 40 numbers out of 100 a limited fill will be performed. Furthermore, values of 0 through 1 are purely exemplary and may be replaced by any other number ranges.

In one embodiment, a lower allocation probability increases the probability of performing a limited fill in response to a cache allocation request and consequently reduces the cache utilization of a corresponding program class. In one embodiment, the difference between the monitored occupancy rate and requested occupancy rate 102 associated with program class A is reduced by regulating allocation probability 112 in conjunction with a feedback mechanism including a proportional-integral-derivative controller (PID controller). In one embodiment, the monitored occupancy rate gradually approaches requested occupancy rate 102. In one embodiment, the monitored occupancy rate and requested occupancy rate 102 converge eventually.

In one embodiment, PI controller 120 and monitor logic 160 regulate allocation probability 112 by using other performance metrics, such as, for example, instructions per cycle (IPC) and misses per instruction (MPI).

In one embodiment, a computer system further includes memory (not shown) to store associations of a program and a corresponding core on which the program executing. In one embodiment, the memory further stores a quality of service requirement (QoS), priority information (e.g., levels of priority), etc. associated with each program class.

In one embodiment, computer system registers (not shown), accessible by an operating system, are used for configuring comparison logic 170, monitor logic 160, and PI controller 120. In one embodiment, PI controller 120, monitor logic 160, and comparison logic 170, operate independently of an operating system. In one embodiment, monitor logic 160 and comparison logic 170 operate in conjunction with an operating system to regulate cache occupancy rates of different program classes.

In one embodiment, an operating system schedules time (time-slicing) to different applications based on their priorities. A low priority program is allocated with a shorter time-slice than a high priority program. In one embodiment, such time-slicing is not effective in controlling an occupancy rate associated with each program class. In one embodiment, the performance degradation caused by resource contention is mitigated by regulating the allocation probabilities of program classes.

In one embodiment, a processor includes multiple processing elements. A processing element comprises a thread, a process, a context, a logical processor, a hardware thread, a core, an accelerator core, or any processing element, which shares access to other shared resources of a processor, such as, for example, reservation units, execution units, higher level caches, memory, etc. In one embodiment, a processing element is a thread unit, i.e. an element which is capable of having instructions independently scheduled for execution by a software thread. In one embodiment, a physical processor is an integrated circuit, which includes any number of other processing elements, such as cores or hardware threads. In one embodiment, a hardware thread, a core, or a processing element is viewed by an operating system or management software as an individual logical processor. Software programs are able to individually schedule operations on each logical processor. Additionally, in some embodiments, each core includes multiple hardware threads for executing multiple software threads.

In one embodiment, a hypervisor (not shown) provides an interface between software (e.g., virtual machines) and hardware resource (e.g., a processor). In one embodiment, a hypervisor abstracts hardware so that multiple virtual machines run independently in parallel. In one embodiment, a virtual machine provides a software execution environment for a program, such as, for example, a task, a user-level application, guest software, an operating system, another virtual machine, a virtual machine monitor, other executable code, or any combination thereof. In one embodiment, a hypervisor allocates hardware resources (e.g., a core, a hardware thread, a processing element) to different programs.

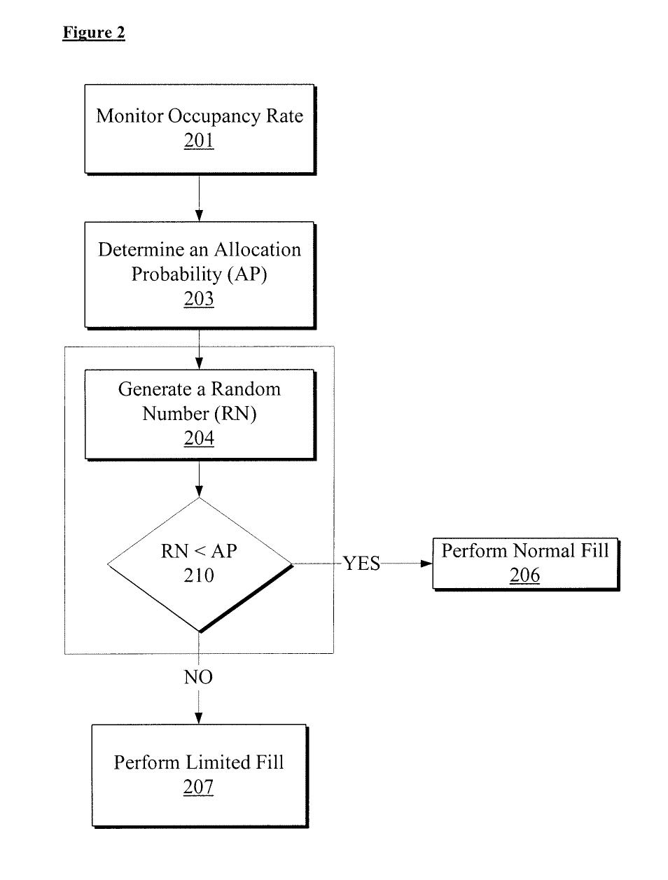

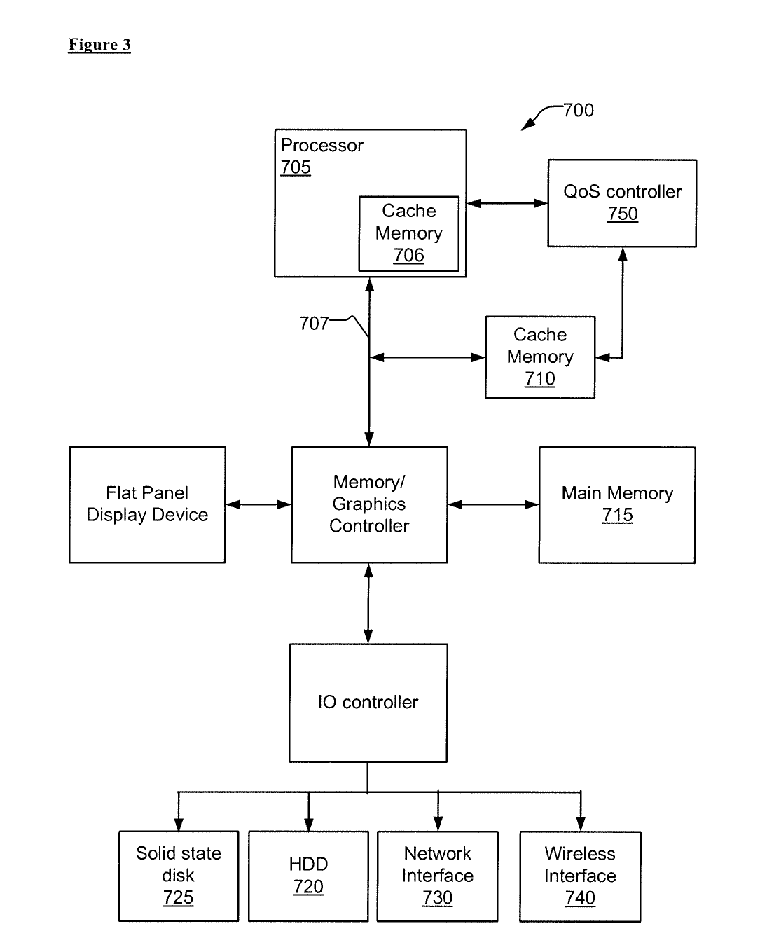

FIG. 2 is a flow diagram of one embodiment of a process to control cache occupancy rates. The process is performed by processing logic that may comprise hardware (circuitry, dedicated logic, etc.), software (such as is run on a general purpose computer system or a dedicated machine), or a combination of both. In one embodiment, the process is performed in conjunction with a controller (e.g., PI controller 120 with respect to FIG. 1). In one embodiment, the process is performed by a computer system with respect to FIG. 3.

In one embodiment, processing logic begin by monitoring a cache occupancy rate associated with a program class (process block 201). In one embodiment, processing logic determines the occupancy rates based on utilization associated with the program class within a sample portion of a cache memory.

In one embodiment, processing logic determines an allocation probability corresponding to the program class (process block 203). In one embodiment, processing logic sets the initial value of the allocation probability according to a corresponding requested occupancy rate. In one embodiment, processing logic determines the allocation probability in conjunction with a feedback mechanism including a proportional-integral-derivative controller (PID controller).

In one embodiment, processing logic determines probabilistically, in response to a cache allocation request, whether or not to perform a limited fill based on the allocation probability. In one embodiment, processing logic generates a random number (process block 204).

In one embodiment, processing logic compares the random number with an allocation probability (process block 210). In one embodiment, processing logic determines to perform a limited fill if the random number is larger than the allocation probability (process block 206). Otherwise, processing logic determines to perform a normal fill (process block 207).

In one embodiment, processing logic regulates the allocation probability continually to minimize the difference between a monitored occupancy rate and the requested occupancy rate. In one embodiment, processing logic is able to increase or to decrease an allocation probability based on the whether a monitored occupancy rate is in an underflow condition or an overflow condition respectively.

In one embodiment, processing logic updates occupancy rates corresponding to different program classes. The priority levels of the program classes are different from each others. In one embodiment, processing logic assigns a priority level to a cache allocation request based on from which program class the cache allocation request originates.

Embodiments of the invention may be implemented in a variety of electronic devices and logic circuits. Furthermore, devices or circuits that include embodiments of the invention may be included within a variety of computer systems. Embodiments of the invention may also be included in other computer system topologies and architectures.

FIG. 3, for example, illustrates a computer system in conjunction with one embodiment of the invention. Processor 705 accesses data from level 1 (L1) cache memory 706, level 2 (L2) cache memory 710, and main memory 715. In other embodiments of the invention, cache memory 706 may be a multi-level cache memory comprise of an L1 cache together with other memory such as an L2 cache within a computer system memory hierarchy and cache memory 710 are the subsequent lower level cache memory such as an L3 cache or more multi-level cache. Furthermore, in other embodiments, the computer system may have cache memory 710 as a shared cache for more than one processor core.

In one embodiment, the computer system includes quality of service (QoS) controller 750. In one embodiment, Qos controller 750 is coupled to processor 705 and cache memory 710. In one embodiment, QoS controller 750 regulates cache occupancy rates of different program classes to control resource contention to shared resources. In one embodiment, QoS controller 750 includes logic such as, for example, PI controller 120, comparison logic 170, or any combinations thereof with respect to FIG. 1. In one embodiment, QoS controller 750 receives data from monitoring logic (not shown) with respect to performance of cache occupancy, power, resources, etc.

Processor 705 may have any number of processing cores. Other embodiments of the invention, however, may be implemented within other devices within the system or distributed throughout the system in hardware, software, or some combination thereof

Main memory 715 may be implemented in various memory sources, such as dynamic random-access memory (DRAM), hard disk drive (HDD) 720, solid state disk 725 based on NVRAM technology, or a memory source located remotely from the computer system via network interface 730 or via wireless interface 740 containing various storage devices and technologies. The cache memory may be located either within the processor or in close proximity to the processor, such as on the processor's local bus 707. Furthermore, the cache memory may contain relatively fast memory cells, such as a six-transistor (6T) cell, or other memory cell of approximately equal or faster access speed.

Other embodiments of the invention, however, may exist in other circuits, logic units, or devices within the system of FIG. 3. Furthermore, in other embodiments of the invention may be distributed throughout several circuits, logic units, or devices illustrated in FIG. 3.

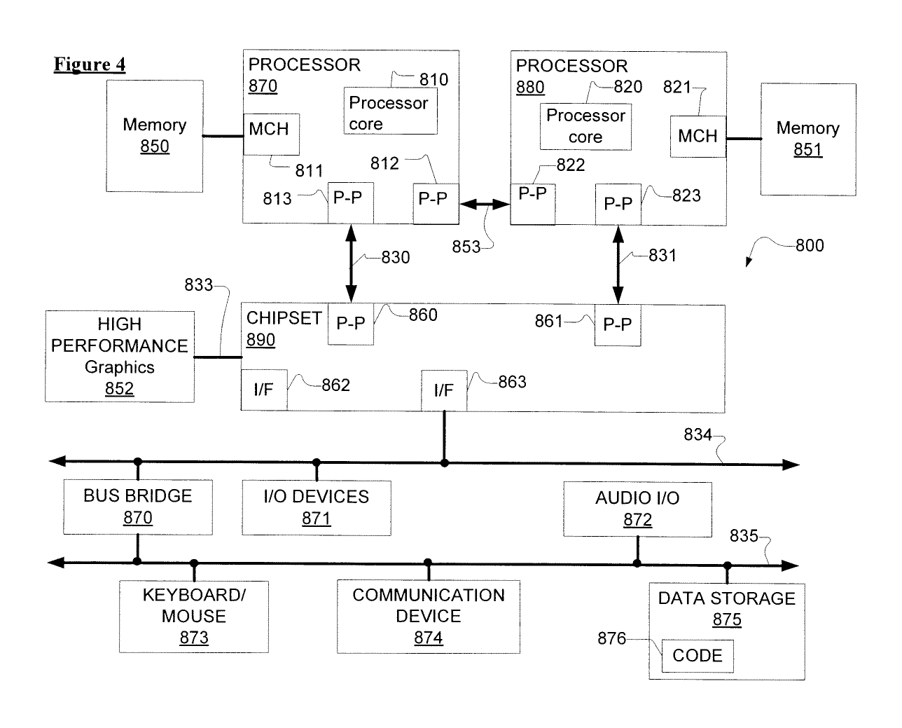

Similarly, at least one embodiment may be implemented within a point-to-point computer system. FIG. 4, for example, illustrates a computer system that is arranged in a point-to-point (PtP) configuration. In particular, FIG. 4 shows a system where processors, memory, and input/output devices are interconnected by a number of point-to-point interfaces.

The system of FIG. 4 may also include several processors, of which only two, processors 870, 880 are shown for clarity. Processors 870, 880 may each include a local memory controller hub (MCH) 811, 821 to connect with memory 850, 851. Processors 870, 880 may exchange data via a point-to-point (PtP) interface 853 using PtP interface circuits 812, 822. Processors 870, 880 may each exchange data with a chipset 890 via individual PtP interfaces 830, 831 using point to point interface circuits 813, 823, 860, 861. Chipset 890 may also exchange data with a high-performance graphics circuit 852 via a high-performance graphics interface 862. Embodiments of the invention may be coupled to computer bus (834 or 835), or within chipset 890, or coupled to data storage 875, or coupled to memory 850 of FIG. 4.

Other embodiments of the invention, however, may exist in other circuits, logic units, or devices within the system of FIG. 4. Furthermore, in other embodiments of the invention may be distributed throughout several circuits, logic units, or devices illustrated in FIG. 4.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chipset components, programmable logic arrays (PLA), memory chips, network chips, or the like. Moreover, it should be appreciated that exemplary sizes/models/values/ranges may have been given, although embodiments of the present invention are not limited to the same. As manufacturing techniques (e.g., photolithography) mature over time, it is expected that devices of smaller size could be manufactured.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. An apparatus comprising:
monitor logic to determine a first monitored occupancy rate associated with a first program class; and
a first controller, coupled to the monitor logic, to regulate a first allocation probability corresponding to the first program class, based at least on a difference between a first requested occupancy rate and the first monitored occupancy rate.

2. The apparatus of claim 1, wherein the first controller comprises a proportional-integral controller (PI controller) and a feedback mechanism, to regulate the first allocation probability to cause the first monitored occupancy rate to approach the first requested occupancy rate.

3. The apparatus of claim 1, wherein the first controller comprises a proportional-integral controller (PI controller) to regulate the first allocation probability to cause a reduction in an overflow or an underflow associated with the first monitored occupancy rate.

4. The apparatus of claim 1, wherein the first requested occupancy rate is set based on system configurations.

5. The apparatus of claim 1, the first monitored occupancy rate is based on results from monitoring utilization, associated with the first program class, within a sample portion of a cache memory.

6. The apparatus of claim 1, further comprising a second controller to regulate a second allocation probability corresponding to a second program class, wherein the first program class and the second program class are of different priority levels.

7. The apparatus of claim 1, further comprising:
number generation logic to generate a comparison number;
cache control logic to perform a limited fill in response to an allocation request associated with the first program class, if the comparison number is greater than the first allocation probability.

8. A system comprising:
a processor including
a cache memory;
monitor logic, coupled to the cache memory, to determine a first monitored occupancy rate associated with a first program class; and
a first controller to regulate a first allocation probability corresponding to the first program class, based at least on a difference between the first requested occupancy rate and the first monitored occupancy rate; and
a memory coupled to the processor to hold information about the first requested occupancy rates and the first program class.

9. The system of claim 8, wherein the first controller comprises a proportional-integral controller (PI controller) and with a feedback mechanism, to regulate the first allocation probability to cause the first monitored occupancy rate to approach the first requested occupancy rate.

10. The system of claim 8, further comprising a second controller to regulate a second allocation probability corresponding to a second program class, wherein the first program class and the second program class are of different execution priority levels.

11. The system of claim 8, further comprising:
number generation logic to generate a comparison number;
cache control logic to perform a limited fill in response to an allocation request associated with the first program class, if the comparison number is greater than the first allocation probability.

12. A method comprising:
generating a first allocation probability associated with a first program class based at least on a difference between a first monitored occupancy rate and a first requested occupancy rate; and
determining probabilistically whether or not to perform a limited fill, in response to a cache allocation request associated with the first program class, based on the firsts allocation probability.

13. The method of claim 12, further comprising regulating, in conjunction with a feedback mechanism, the first allocation probability to cause the first monitored occupancy rate to approach the first requested occupancy rate.

14. The method of claim 12, further comprising monitoring utilization associated with the first program class within a sample portion of a cache memory.

15. The method of claim 12, further comprising assigning a priority level to the cache allocation request associated with the first program class.

16. The method of claim 12, further comprising generating a second allocation probability associated with a second program class based at least on a difference between a second monitored occupancy rate and a second requested occupancy rate, wherein the first program class and the second program class are of different priority levels.
